(19) United States
(12) Patent Application Publication
(10) Pub. No.: US 2020/0385562 A1
(43) Pub. Date: Dec. 10, 2020

(54) ALIPHATIC POLYKETONE MODIFIED WITH CARBON NANOSTRUCTURES

(71) Applicant: ESPRIX TECHNOLOGIES, LP., Sarasota, FL (US)

(72) Inventors: Cary VEITH, Lakewood Ranch, FL (US); Dang M. LE, Missouri City, TX (US)

(21) Appl. No.: 16/491,611

(22) PCT Filed: Feb. 28, 2018
(86) PCT No.: PCT/US2018/020104

§ 371 Date: Sep. 6, 2019

Related U.S. Application Data
(60) Provisional application No. 62/600,866, filed on Mar. 7, 2017.

(51) Int. Cl. C08L 29/12; C08K 3/04; C08K 7/14; C08F 116/36

(52) U.S. Cl. CPC C08L 29/12; C08K 3/041; C08K 2201/014; C08F 116/36; C08K 7/14

(57) ABSTRACT

Aliphatic polyketone polymer compositions modified with carbon nanostructures, particularly carbon nanotubes are provided that dramatically improve mechanical, electrical conductivity and thermal conductivity properties. The provided compositions may be used to produce melt-processable, engineering thermoplastic parts for a wide range of applications such as in automotive, industrial, electrical and electronics, oil & gas and consumer industries.

### CROSS REFERENCE TO RELATED APPLICATIONS

This application depends from and claims priority to U.S. Provisional Application No. 62/600,866 filed Mar. 7, 2017, the entire contents of which are incorporated herein by reference.

### FIELD

The present disclosure is directed to plastic materials and their manufacture. More specifically, this disclosure is related to thermoplastic materials suitable for use in melt-processable applications.

### BACKGROUND

Polymer blends of engineering thermoplastics with reinforcement and other additives are economical and efficient ways to produce new materials. By blending materials with different physical properties, such as varying tensile strength and modulus, filler axial ratio, and transport properties, new materials exhibiting a substantial combination of all the components can be produced.

Aliphatic polyketone (PK) resins have been recently reintroduced into the engineering polymers industry. Shell Chemical first commercialized these resins in the 1990's but shuttered the business in 2000. More recently, Hyosung Corporation has reintroduced PK resins through manufacture at their commercial-scale facility in Ulsan, South Korea.

Aliphatic polyketone (PK) resins are linear, alternating copolymers of carbon monoxide, and at least one ethylenically unsaturated hydrocarbon. Typical PK copolymers are actually terpolymers of carbon monoxide which alternates with a mixture of two ethylenically unsaturated hydrocarbon monomers, preferably ethylene and another alpha-olefin such as propylene.

Aliphatic polyketone polymers are well known. U.S. Pat. No. 2,495,286 to Brubaker discloses polymers of carbon monoxide and ethylenically unsaturated monomers. U.S. Pat. No. 3,689,460 to Nozaki discloses a process of producing high molecular weight polyketone polymers using palladium catalysts. Shell Chemical Company, Ltd is the assignee on a number of US and WPO patents regarding compounds of PK and various additives, such as U.S. Pat. No. 5,719,238 to Flood et.al., and U.S. Pat. No. 5,432,220 to Ash and all references cited therein.

Polymer blends of PK are well known in the art. Examples are Lutz, U.S. Pat. No. 4,816,514 who described blends of PK and small amounts of polyolefin polymers; Gergen et.al., U.S. Pat. No. H917 who found improved processability from blends of PK with maleated polyolefins; and Chmielewski, U.S. Pat. No. 6,147,158, who blended PK with functionalized olefins such as maleic anhydride-polyethylene, polyamides and non-functionalized polyolefins such as High Density PolyEthylene (HDPE).

Other polymer blends of engineering thermoplastics including PK with reinforcement such as chopped glass or carbon fiber are well known in the art. Machado U.S. Pat. No. 5,274,040 describes a compound consisting of PK, an uncured phenolic-based novolac resin and glass fiber with improved mechanical properties.

Glass and/or carbon fibers have long been known to improve mechanical properties of polymer resins. However, most compounding methods mentioned above will reduce fiber length and hence, high loadings (15-40 wt %) are required to achieve the improvement in mechanical strength or modulus. Ductility is usually lost and strains at break are reduced to only a few percent due to the high loadings of the stiff and brittle fibers. Furthermore, there is likely to be a minimal increase in electrical or thermal conductivity using these fiber reinforcements.

Carbon nanotubes have been utilized in thermoplastic blends of polycarbonate-polyorganosiloxane copolymers with flame retardants as described by Nodera, in U.S. Pat. No. 7,307,120. The use of carbon nanotubes as additives in other polymer blends have been disclosed in many thermoset systems as shown by Tilbrook, et.al., U.S. Pat. No. 8,097,333. However, these thermoset systems need a final cure step in order to make a useful part.

As such, there are new materials and methods needed to utilize polymeric materials in melt-processable operations and to improve mechanical properties as well as electrical and thermal conductivity.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are compositions that include a melt processable, aliphatic polyketone intermixed with carbon nanostructures. The resulting compositions convey a substantial improvement in mechanical, electrical and thermal properties of the composition over the neat aliphatic polyketone resin or other known additives that are traditionally used to convey this improvement in properties.

Also provided are processes of forming a composition whereby a CNS is first produced by commercial methods, dried, packaged and sold to a compounder. The compounder then feeds the CNS with the PK resin plus other processing aids, additives and thermal stabilizers into a suitable compounding device such as a twin screw extruder. PK/CNS compounds can be produced directly in a single pass, then pelletized, dried and packaged for subsequent processing as described above (single-screw extrusion, injection molding, blow molding, etc.).

A second variation of the invention relates to producing by the same processes as described in the first variation a masterbatch consisting of a higher (e.g. 5-10 wt %) concentration of CNS in PK on conventional plastic compounding equipment such as a twin-screw extruder. Then, the PK/CNS masterbatch (MB) is added into a second plastic compounding device along with more PK resin, processing aids, thermal stabilizers plus any other desired additives (such as flame retardants, glass fiber, carbon fiber, colorants, additional thermal or electrical conductivity improvement additives, etc.) and reprocessed to reach the targeted concentration of CNS (up to e.g. 0.1-10 wt %).

A third variation of the invention is that for some applications, higher loadings of CNS are desired and the MB is used directly or is reprocessed with limited additional additives to achieve the desired final set of properties. Essentially, there is no limit on the concentration of CNS except that imposed by the processing equipment as to how high a loading of CNS can be achieved.

The invention is not limited to a specific grade or type of polyketone. Polyketone is a non-hazardous polymer prepared by polymerizing ethylene, propylene and carbon monoxide and could even be considered an environmentally friendly polymer. For many automotive, industrial, electrical and consumer applications, PK has many desirable properties such as low moisture pick-up, good flexural strength and modulus, good impact strength, high tear-resistance, dimensional stability and better solvent resistance than more traditional polymers such as polyamides, polyacetals and polyesters.

### DETAILED DESCRIPTION

The following description of particular aspect(s) is merely exemplary in nature and is in no way intended to limit the scope of the invention, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

This disclosure provides thermoplastic combinations of one or more polyketone polymers (PK) combined with nanostructured carbon materials that may be used in melt-processable operations. Including the carbon nanostructures (CNS) additives in a PK as provided in this disclosure, there is the unexpected result that substantial improvement in mechanical properties and electrical and thermal conductivity can be achieved with very low loadings of nanostructured carbon (e.g. 10 wt % or less or 3 wt % or less, optionally 10 wt % to 0.3 wt % or any value or range therebetween) in the overall composition. The compositions provided herein may be prepared in pellet form and supplied for use in conventional melt processing, thermal forming processes such as injection molding, compression molding, thermoforming, extrusion and rotomolding.

As such, a composition includes one or more polyketone polymers combined with one or more carbon nanostructures. Polyketone polymers are linear alternating polymers of carbon monoxide and one or more ethylenically unsaturated hydrocarbons. Typical PK materials include one molecule of carbon monoxide for one or more molecules of olefins.

Illustrative examples of ethylenically unsaturated hydrocarbons as a component of a PK include, but are not limited to alpha olefin compounds such as ethylene, propylene, 1-butene, or mixtures thereof. An ethylenically unsaturated alpha-olefin can optionally include between 2 and 10 carbons, optionally between 2 and 4 carbons, optionally 2-3 carbons. As such, additional illustrative ethylenically unsaturated hydrocarbons include propene, 1-butene, 1-hexene and 1-octene, etc.

A PK is optionally a copolymer of CO and a single ethylenically unsaturated hydrocarbons or a terpolymer of CO and two differing ethylenically unsaturated hydrocarbons. A terpolymer optionally includes as the first ethylenically unsaturated hydrocarbon an ethylene and as a second ethylenically unsaturated hydrocarbons a C2-C10 ethylenically unsaturated hydrocarbon. In some aspects a second ethylenically unsaturated hydrocarbon is a C3-C4 ethylenically unsaturated hydrocarbon, optionally propylene. In a terpolymer of CO with two or more ethylenically unsaturated hydrocarbons, an ethylene is optionally present at a molar predominant relative to a second ethylenically unsaturated hydrocarbon.

When a PK is a terpolymer, the first ethylenically unsaturated hydrocarbon is optionally present at a molar predominant relative to the second ethylenically unsaturated hydrocarbon. Optionally, the second ethylenically unsaturated hydrocarbon is present a less than 10 molar percent of the first ethylenically unsaturated hydrocarbon, optionally less than 3 molar percent of the first ethylenically unsaturated hydrocarbon, optionally less than 1 molar percent of the first ethylenically unsaturated hydrocarbon. Optionally, a first ethylenically unsaturated hydrocarbon is ethylene, and a second ethylenically unsaturated hydrocarbon is propylene present at 10 molar percent or less relative to the ethylene, optionally 3 molar percent or less relative to the ethylene, optionally 1 molar percent or less relative to the ethylene.

A PK is optionally provided at an average molecular weight of 1000 Da to 300,000 Da or any value or range therebetween. Optionally, an average molecular weight is from 10,000 Da to 300,000 Da. Optionally, an average molecular weight is from 50,000 Da to 300,000 Da.

Specific illustrative examples of PK include those sold as AKROTEK, CARILON, KETOPRIX, or SCHULAKETON. Other illustrative examples of PK include those disclosed in U.S. Pat. Nos. 2,495,286, 3,689,460, 4,816,514, 5,719,238, 5,432,220 or 6,147,158.

A composition also includes one or more carbon nanostructures intermixed with the PK. Carbon nanostructures that may be used include carbon nanotubes such as single walled or double walled carbon nanotubes. Carbon nanotubes are commercially available in several forms that vary according to the diameter, the length, and the linking of the carbon atoms. Illustratively, carbon nanotubes are available in small diameter (0.8 to 1.2 nm) single-wall nanotubes such as those sold under the trade name HiPco® by NanoIntegris (Skokie, Ill.), multi-wall structures (Multi-Wall Carbon Nanotubes: MWCNTs), or as chopped structures such as those sold by Applied Nanostructured Solutions, LLC (Baltimore, Md.). In general, the diameter of carbon nanotubes is optionally between 0.5 and 30 nm and their length may reach several micrometers or more. Other illustrative structures of CNS include those described in U.S. Patent Application Publication No: 2014/0093728.

It was unexpectedly found that the addition of low amounts of CNS relative to PK would impart both mechanical robustness and electrical and thermal conductivity without the need for additional structural support such as in the form of glass or other support materials typically used to mechanically support polymeric materials or convey high electrical or thermal conductivity. As such, in some aspects, the weight percent of CNS relative to PK is optionally 10 or less, optionally 9 or less, optionally 8 or less, optionally 7 or less, optionally 6 or less, optionally 5 or less, optionally 4 or less, optionally 3 or less, optionally 2 or less, optionally 1 or less, optionally 0.5 or less, optionally 0.1 or less. In some aspects, the weight percent of CNS is 0.1 to 3 or any value or range therebetween.

It is appreciated that the weight percent CNS in PK is not necessarily limited to 10 weight percent or less, or 3 weight percent or less. In some aspects a masterbatch of material is made whereby the amount of CNS added to PK is at a weight percent of 5 to 10, or any value or range therebetween. Such a masterbatch can then be combined with additional PK to effectively reduce the final weight percent of CNS to less than 10, optionally 0.1 to 3.0 weight percent. In the forming of the final material the additional PK may be added along with one or more of processing aids, thermal stabilizers, antioxidants, or any other desired additives (e.g. flame retardants, glass fiber, carbon fiber, colorants, additional thermal or electrical conductivity improvement additives, etc.) so that a final use batch is achieved with the desired mechanical, electrical and thermal properties.

Optionally, higher loadings of CNS are provided with the PK in the formation of a masterbatch that may be used directly or reprocessed with the inclusion of additional PK or other one or more processing aids, thermal stabilizers, antioxidants or any other desired additives (e.g. flame retardants, glass fiber, carbon fiber, colorants, additional thermal or electrical conductivity improvement additives, etc.).

As noted above, one or more additives may be further included with the PK and CNS in the composition. Optionally, one or more additives may impart additional or augmented chemical, electrical, or physical properties to the final composition. Optionally, one or more additives are included in a composition. Optionally, 2, 3, 4, or more additives are included. Illustrative examples of additives include but are not limited to fiber reinforcement, flame retardants, colorants, lubricants, wear additives, surface modifiers, stabilizers, mold release agents, antioxidants, electrical conductivity additives, thermal conductivity additives and processing aids. An additive, when present is optionally provided at or less than 75 weight percent, optionally at or less than 50 weight percent, optionally at or less than 10 weight percent, optionally 0.1 to 2 weight percent, optionally 0.1 to 3 weight percent. Optionally, an additive is not necessary to provide the desired mechanical, electrical, or thermal properties of the material. Optionally, a material excludes an electrical conductivity additive, a thermal conductivity additive, mechanical reinforcement, or combinations thereof, other than what is unexpectedly imparted by the addition of CNS with the PK. As such, an additive is optionally excluded. Optionally, a material consists essentially of PK and CNS whereby the inclusion of any other additive does not appreciably alter the beneficial combination of PK and CNS in the final material. Such additives, when present, may be incorporated by conventional methods prior to, together with, or subsequent to the blending of the PK and the CNS.

Optionally, a composition includes one or more lubricants. An illustrative example of a lubricant is optionally silicone oil, illustratively polydimethyl siloxane. A silicone oil optionally has a viscosity of 1,000 to 300,000 centistokes. Optionally, a lubricant is a fatty acid, optionally a carboxylate of a fatty acid, optionally a stearate, optionally calcium stearate.

A number of techniques can be utilized to produce PK/CNS compounds such as twin screw compounding extrusion, Banbury mixing, FCM (Farrel Continuous Mixer) or LCM (Long Continuous Mixer) processes. The design of the mixing elements should be considered for properly exfoliating the CNS, but is less important for and achieving successful compounding of CNS into PK, When proper screw and/or mixing design is used such as with the exemplary systems as above, CNS can be easily dispersed into PK resins to give the concomitant improvement in properties.

In the formation of a compound as provided herein, one or more aliphatic polyketone resins in pellet form may be tumble blended with CNS optionally from a commercial source, and optionally along with one or more additives such as processing aids (lubricants), antioxidants, or thermal or UV stabilizers and compounded on conventional plastic compounding equipment, such as a twin-screw extruder. The PK/CNS compound produced may then be pelletized, dried, packaged, and sold as a PK/CNS compound. Alternately, the CNS can be fed illustratively via a twin-screw side feeder to a main twin-screw compounding extruder to introduce the CNS into the PK molten resin before pelletizing, drying and packaging.

Alternately, the PK/CNS compound produced above can be used directly in, but not limited to, single screw extrusion, blow molding, injection molding, compression molding or thermoforming operations to produce the desired part. These processes are conventional processes known in the art and make the utility very high for these PK/CNS compounds. Optionally, a resulting production process does not require curing of the composition. These processing steps can be done by the practitioner of the current invention or by a consumer/article manufacturer. The finished part (e.g. pipe, molded, or thermoformed part) can then be used directly in the desired application.

These PK/CNS compounds show unusual mechanical, thermal conductivity and electrical conductivity properties. As such, these PK/CNS compounds are well suited to replace metal in light-weighting of automobiles, aircraft, and marine vessels.

A compound optionally has desirable mechanical properties. Illustratively, a compound has a yield strength in excess of that the PK material alone. Optionally, a yield strength is in excess of 60 MPa, optionally at or in excess of 70 MPa, optionally at or in excess of 80 MPa, optionally at or in excess of 90 MPa, optionally at or in excess of 100 MPa, whereby such yield strength is optionally in the absence of any additive that affects yield strength.

Another mechanical property that is surprisingly achieved by the combination of PK with a relatively small amount of CNS is improved flexural strength. Flexural strength is optionally greater than that of the PK alone. Optionally, flexural strength is greater than 68 MPa, optionally at or greater than 70 MPa, optionally at or greater than 80 MPa, optionally at or greater than 90 MPa, optionally at or greater than 100 MPa, optionally at or greater than 110 MPa, optionally at or greater than 120 MPa, optionally at or greater than 130 MPa, whereby such flexural strength is optionally in the absence of any additive that affects flexural strength.

Flexural modulus is also improved by the addition of CNS with PK at the relatively low amounts. Optionally, flexural modulus is greater than 1.6 GPa, optionally at or greater than 2 GPa, optionally at or greater than 2.5 GPa, optionally at or greater than 3 MPa, optionally at or greater than 3.5 GPa, optionally at or greater than 4 GPa, optionally at or greater than 4.5 GPa, optionally at or greater than 5 GPa, whereby such flexural modulus is optionally in the absence of any additive that affects flexural strength.

As indicated otherwise herein, the addition of CNS at relatively low amounts unexpectedly also improves electrical conductivity. As such, a composition optionally has a volume resistivity of less than 10¹⁵ Ω*cm at 23° C. The volume resistivity is optionally a factor of 13 or more orders of magnitude lower measured in Ω*cm than the PK alone. Optionally, the volume resistivity in Ω*cm is 100 or less, optionally 90 or less, optionally 50 or less, optionally 30 or less, optionally 20 or less, optionally 2 or less, at 2.3° C. The volume resistivity of the compound as provided herein is optionally imparted in the absence of any additive that alters volume resistivity.

The addition of a CNS additive at the relatively low amounts as provided herein also improved thermal conductivity. The thermal conductivity in W/m*K is optionally at or greater than 0.1, optionally at or greater than 0.2, optionally at or greater than 0.3, optionally at or greater than 0.4, optionally at or greater than 0.5, optionally at or greater than 0.6. The thermal conductivity achieved is optionally achieved in the absence of an additive that alters thermal conductivity of the material.

Optionally, two or more of yield strength, flexural strength, flexural modulus, volume resistivity, and thermal conductivity are achieved in the compound optionally without one or more additives to achieve the desired property of the material. Optionally, a compound has a yield strength in excess of that the PK material alone. Optionally, a yield strength is in excess of 60 MPa, optionally at or in excess of 70 MPa, optionally at or in excess of 80 MPa, optionally at or in excess of 90 MPa, optionally at or in excess of 100 MPa. Optionally, flexural strength of the compound is greater than 68 MPa, optionally at or greater than 70 MPa, optionally at or greater than 80 MPa, optionally at or greater than 90 MPa, optionally at or greater than 100 MPa, optionally at or greater than 110 MPa, optionally at or greater than 120 MPa, optionally at or greater than 130 MPa. Optionally, flexural modulus of the compound is greater than 1.6 GPa, optionally at or greater than 2 GPa, optionally at or greater than 2.5 GPa, optionally at or greater than 3 MPa, optionally at or greater than 3.5 GPa, optionally at or greater than 4 GPa, optionally at or greater than 4.5 GPa, optionally at or greater than 5 GPa. A compound optionally has a volume resistivity of less than 10¹⁵ Ω*cm. The volume resistivity is optionally a factor of 10¹³ Ω*cm lower than the PK alone. Optionally, the volume resistivity in Ω*cm is 100 or less, optionally 90 or less, optionally 50 or less, optionally 30 or less, optionally 20 or less, optionally 2 or less. The compound optionally has a thermal conductivity in W/m*K is optionally at or greater than 0.1, optionally at or greater than 0.2, optionally at or greater than 0.3, optionally at or greater than 0.4, optionally at or greater than 0.5, optionally at or greater than 0.6.

Various aspects of the present disclosure are illustrated by the following non-limiting examples. The examples are for illustrative purposes and are not a limitation on any practice of the present invention. It will be understood that variations and modifications can be made without departing from the spirit and scope of the invention.

### EXAMPLES

### Example 1

A 2.5% CNS in PK matrix sample is prepared by first drying (60° C., overnight) 300 pounds (lbs) of aliphatic polyketone resin available from Hyosung Corporation, Seoul, Korea, grade M330A. 7.7 lbs of CNS carbon nanotubes available from Applied Nanostructured Solutions, LLC, Baltimore, Md. are tumble blended in a Henschel or other suitable mixer with the PK resin and 0.3 lbs of calcium stearate (lubricant) and 0.3 lbs of Irganox 1010 (antioxidant). The blended mixture is fed to a 43 mm twin-screw extruder manufactured by Krauss Maffei, Berstorff of Hanover, Germany, with a temperature profile of 450° F. across the barrel and die, operating at 400 rpm. Extrudate is water quenched in a water trough, fed to dryer and pelletizer and collected in suitable packaging such as a box or bag.

### Example 2

A second composition was prepared with 1 wt % CNS in the final composition under the same processing conditions as in Example 1.

The results of the preparation of Examples 1 and 2 are shown in Table 1.

TABLE 1
Comparison of material properties with and without
carbon nanostructures in the formulation.

| | Yield | Flexural | Flexural | Volume | Thermal |
|---|---|---|---|---|---|
| | Strength | Strength | Modulus | Resistivity | Conductivity |
| Material | (MPa) | (MPa) | (GPa) | (Ω*cm) | (W/m*K) |
| PK | 60 | 68 | 1.6 | 10\hat{ }15 | 0.22 |
| PK + 1 | 82 | 108 | 3.3 | 20 | 0.4 |
| wt % CNT | | | | | |
| PK + 2.5 | 100 | 128 | 4.6 | 2 | 0.5 |
| wt % CNT | | | | | |

As is illustrated in Table 1, the addition of 1 wt % of carbon nanotubes in PK increases the yield strength +37%, the flexural strength +59%, the flexural modulus +106%, reduces the volume resistivity by 14 orders of magnitude and improves the thermal conductivity by +82%.

Increasing the concentration of carbon nanotubes to 2.5 wt % in PK increases the yield strength by +67%, the flexural strength by +88%, the flexural modulus +188%, reduces the volume resistivity (inverse of electrical conductivity) by 15 orders of magnitude and improves thermal conductivity by +127%.

Comparable improvements in strength and stiffness of the PK in the absence of 2.5 wt % CNT would require 15-20 wt % chopped glass fiber to be efficiently compounded with PK to produce a glass fiber PK compound. Such additions of support structures are not necessary in the PK/CNT compounds as provided herein.

Likewise, to achieve the high values of electrical conductivity achieved by either the 1 wt % or 2.5 wt % CNT PK compounds, would require 10-15 wt % of conductive carbon black additive yet the addition of carbon black at this high amount would also decrease the strength of the material.

To achieve the increase in thermal conductivity of the PK/CNT compounds as provided herein, 5-10 wt % of conductive graphite would have to be compounded into the PK but would result in a loss of strength.

Clearly, the improvement in electrical and thermal conductivity can be obtained using carbon nanostructures in PK while also increasing strength and modulus of the compound. This is in stark contrast to the often seen decrease in strength and stiffness using conventional additives to boost electrical and thermal conductivity in engineering thermoplastic polymers like PK.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A composition comprising aliphatic polyketone polymer and one or more carbon nanostructures.

2. The composition according to claim 1 whereby the carbon nanostructures are single-walled carbon nanotubes, multi-walled carbon nanotubes, or combinations thereof.

3-5. (canceled)

6. The composition according to claim 1 further comprising glass fiber, or carbon fiber.

7. (canceled)

8. The composition according to claim 1 further comprising one or more additives suitable to increase electrical conductivity of the composition, or suitable to increase thermal conductivity of the composition.

9. (canceled)

10. The composition according to claim 1 further comprising one or more additives selected from the group consisting of flame retardants, colorants, lubricants, wear additives, surface modifiers, stabilizers, antioxidants, electrical conductivity additives, thermal conductivity additives and processing aids.

11. The composition according to claim 1 having a yield strength in excess of 60 MPa.

12. (canceled)

13. The composition according to claim 1 having a flexural modulus in excess of 2 GPa.

14. The composition according to claim 1 having a volume resistivity of 1×10³ Ω*cm or lower.

15. The composition according to claim 1 having a thermal conductivity of 0.3 W/m*K or greater.

16. (canceled)

17. A process of producing a composition comprising aliphatic polyketone and one or more carbon nanostructures comprising:
combining an aliphatic polyketone and one or more carbon nanostructures in a compounder, the compounder selected from the group consisting of a twin-screw compounding extruder, Farrel Continuous Mixer, Long Continuous Mixer, Banbury Mixer, and a two-roll mill; and
compounding the aliphatic polyketone and one or more carbon nanostructures to form the composition.

18. The process according to claim 17 the compounding is by a single pass on said compounder.

19. The process according to claim 17 wherein said step of compounding forms a masterbatch, the process further comprising:
subjecting the masterbatch to a second step of compounding in said compounder or a second compounder, the subjecting with additional aliphatic polyketone or one or more additives selected from the group consisting of fiber reinforcement, flame retardants, colorants, lubricants, wear additives, surface modifiers, stabilizers, antioxidants, electrical conductivity additives, thermal conductivity additives and processing aids.

20. The process according to claim 17 whereby the carbon nanostructures are single-walled carbon nanotubes, multi-walled carbon nanotubes, or combinations thereof.

21-23. (canceled)

24. The process according to claim 17 further comprising adding glass fiber or carbon fiber to the composition.

25. (canceled)

26. The process according to claim 17 further comprising adding one or more additives suitable to increase electrical conductivity or thermal conductivity of the composition to the step of compounding.

27-28. (canceled)

29. The process according to claim 17 wherein the composition has a yield strength in excess of 60 MPa.

30. The process according to claim 17 wherein the composition has a flexural strength in excess of 70 MPa.

31. The process according to claim 17 wherein the composition has a flexural modulus in excess of 2 GPa.

32. The process according to claim 17 wherein the composition has a volume resistivity of 1×10³ Ω*cm or lower.

33. The process according to claim 17 wherein the composition has a thermal conductivity of 0.3 W/m*K or greater.
